(19) United States
(12) Patent Application Publication
(10) Pub. No.: US 2018/0311714 A1
(43) Pub. Date: Nov. 1, 2018

(54) TENDON PROCESSING SYSTEM AND METHOD

(71) Applicant: Actuant Corporation, Menomonee Falls, WI (US)

(72) Inventors: Shane Taylor, Hurst, TX (US); Nate Mikulsky, Brookfield, WI (US); Stephan Klatt, Houston, TX (US); Adam Work, Richmond, TX (US); Adam Spivey, Houston, TX (US)

(21) Appl. No.: 15/965,170

(22) Filed: Apr. 27, 2018

Related U.S. Application Data
(60) Provisional application No. 62/491,836, filed on Apr. 28, 2017.

(51) Int. Cl. B21C 37/04; B23D 15/14; B21C 47/02

(52) U.S. Cl. CPC B21C 37/045; B21C 47/02; B23D 15/14

(57) ABSTRACT

A tendon processing system includes at least one tub for supporting a tendon, and an indexing assembly for moving the tub to and between a plurality of processing locations. Each processing location is associated with at least one respective processing device.

### CROSS-REFERENCE TO RELATED APPLICATION

This application claims the benefit of co-pending, prior-filed U.S. Provisional Patent Application No. 62/491,836, filed Apr. 28, 2017, the entire contents of which are incorporated by reference herein.

### BACKGROUND

The present invention generally relates to tendons for use in concrete structures and, more particularly, to systems, devices and methods of processing such tendons.

### SUMMARY

Conventional tendon processing methods are labor intensive, requiring operator handling of the tendon during and through the processing steps. The related processing systems also occupy a large work space. Specifically, in a conventional cutting line, a number of tendon-receiving tubs are anchored to the floor in fixed positions spaced about the work shop. Tendon is fed from a fixed dispensing and cutting device to a selected tub. Each tub “station” must be staffed by one or more operators. After cutting, the tendon must be removed from the tub and moved to other stations, which occupy additional floor space, for further processing.

In one independent aspect, a tendon processing system includes at least one tub for supporting a tendon, and an indexing assembly for moving the tub to and between a plurality of processing locations. Each processing location is associated with at least one respective processing device.

In another independent aspect, a tendon processing system includes a tendon processing device and a tub for supporting a tendon. At least one of the tendon processing device and the tub is selectively positionable adjacent the other of the tendon processing device and the tub to permit processing of the tendon. At least one of the tendon processing device and the tub is movable away from the other of the tendon processing device and the tub after processing.

In yet another independent aspect, a method of processing a tendon includes: positioning a processing device and a tub for supporting a tendon adjacent one another; processing the tendon; and after processing the tendon, moving at least one of the processing device and the tub away from one another.

In some independent aspects, a tendon processing system generally includes a tub for holding tendon and an indexing assembly for moving the tub to and between processing locations associated with respective processing devices. In some constructions, the system includes a number of tubs supported and movable by the indexing assembly.

In some constructions, the indexing assembly may include a rotating turntable supporting the tub(s) for movement to and between different processing devices. In another construction, the indexing assembly may be operable to move the tub(s) generally linearly (e.g., along a line of processing devices) vertically, horizontally, combinations thereof, etc. In some constructions, the devices may include a tendon dispensing/cutting device, a tendon banding/tie device, an anchor (intermediate or dead-end) placement device, a tendon marking device, a material handling device, etc.

In some constructions, the tub includes a receptacle for receiving and containing the tendon. In some constructions, the tub is supported by a pivot shaft for movement about an axis of the pivot shaft.

In some independent aspects, a tendon processing system generally includes a tendon processing device and a tub for holding tendon, the tub and the device being relatively positionable for processing of the tendon, after processing, the tub and/or the device being moved out of a processing position. The tub with the processed tendon and a second processing device may be relatively positionable for further processing of the tendon. A second tub and the processing device may be relatively positionable for processing of another tendon.

In some constructions, the tub moves relative to the device. For example, the tub(s) may be supported on a rotating turntable to move between the device and a second processing device. As another example, the tub(s) may be supported to move generally linearly (e.g., along a line of processing devices) vertically, horizontally, combinations thereof, etc.

In some constructions, the device may include a tendon dispensing/cutting device, a tendon banding/tie device, an anchor (intermediate or dead-end) placement device, a tendon marking device, a material handling device, etc.

In some constructions, the tendon processing device includes a dispenser and a shear, wherein the dispenser is configured to dispense the tendon into the tub and the shear is configured to cut the tendon to a predetermined length. In some constructions, the dispenser includes a conveyor and a guide, wherein the conveyor is configured to move the tendon and the guide is configured to direct the tendon into the tub.

In some independent aspects, a method of processing a tendon may be provided. The method may generally include positioning a processing device and a tub for holding a tendon for processing of the tendon; processing the tendon; and, after processing, moving the tub and/or the device out of the processing position.

The method may further include positioning the tub and a second processing device in a processing position for further processing of the tendon. The method may further include positioning a processing device and a tub for holding a tendon for processing of the tendon; processing the tendon; and, after processing, moving the tub and/or the device out of the processing position.

In some constructions, positioning includes moving the tub relative to the device. For example, moving may include rotating a turntable to move the tub(s) between the device and a second processing device. As another example, moving may include moving the tub(s) generally linearly (e.g., along a line of processing devices) vertically, horizontally, combinations thereof, etc.

In some constructions, processing may include dispensing/cutting the tendon, banding/tying the tendon, placing an anchor (intermediate or dead-end) on the tendon, marking the tendon, handling the tendon, etc.

Independent features and independent advantages may become apparent to those skilled in the art upon review of the detailed description, drawings and claims.

### BRIEF DESCRIPTION OF THE DRAWINGS

FIG. 1 is a perspective view of a system for processing a tendon.

FIG. 2 is a perspective view of a portion of an alternative construction of a system for processing a tendon.

FIG. 3 is a flow chart illustrating a method of processing a tendon.

FIG. 4 is a flow chart illustrating a method of tendon processing.

### DETAILED DESCRIPTION

Before any independent embodiments of the invention are explained in detail, it is to be understood that the invention is not limited in its application to the details of construction and the arrangement of components set forth in the following description or illustrated in the following drawings. The invention is capable of other independent embodiments and of being practiced or of being carried out in various ways. Also, it is to be understood that the phraseology and terminology used herein is for the purpose of description and should not be regarded as limiting.

Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed.

Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

Many of the modules and logical structures described are capable of being implemented in software executed by a microprocessor or a similar device or of being implemented in hardware using a variety of components including, for example, application specific integrated circuits (“ASICs”). Terms like “controller” and “module” may include or refer to both hardware and/or software. Capitalized terms conform to common practices and help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

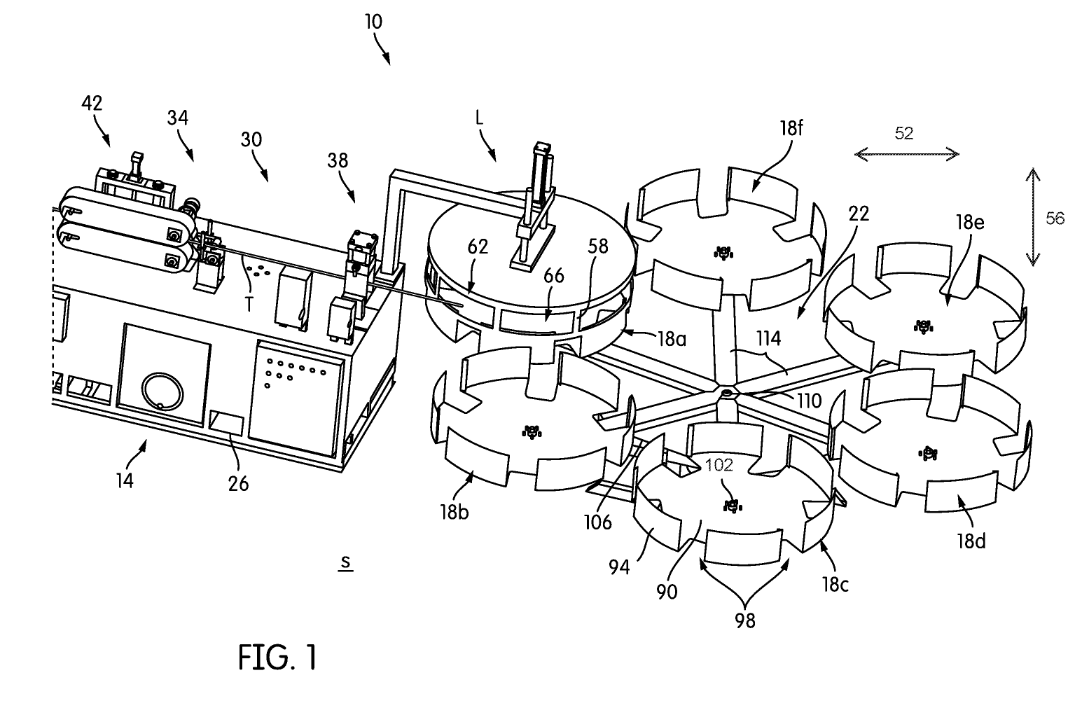

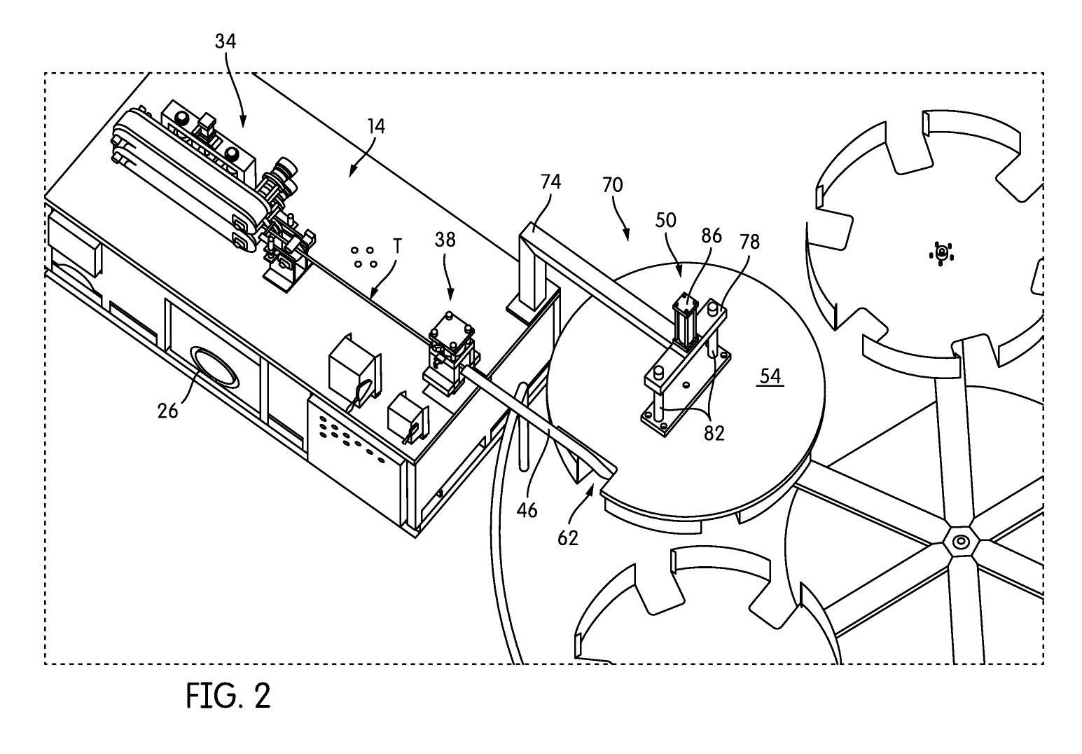

FIGS. 1-2 illustrate a system 10 for processing tendon T. The system 10 includes one or more processing devices 14 (one shown) for processing the tendon T and one or more tubs 18a, 18b . . . 18n for holding a tendon Ta, Tb . . . Tn during processing. The illustrated system 10 also includes an indexing assembly 22 to move each tub 18 into position adjacent the device 14 for processing the tendon T and then away from the device 14 for further processing. This arrangement may, for example, reduce the labor, space, cost, etc. typically required for processing tendon T.

In the illustrated construction, one of the tubs 18 and the processing device 14 are in a first position (e.g., in a “processing position”) for processing of the tendon T held by the tub 18. Subsequently, the tub 18 and the device 14 are moved out of the processing position (e.g., for further processing of the tendon T in the tub 18 by another device, for processing by the device 14 of another tendon T held in another tub, etc.).

The device 14 includes a frame 26 supported on (e.g., in the illustrated construction, anchored or fixed in a location L) a surface S in a work shop. A processing assembly 30 is supported on the frame 26 to conduct an associated process on the tendon T. In the illustrated construction, the device 14 includes a tendon dispensing and cutting device from which tendon T is dispensed into a tub 18 and cut to length. The illustrated processing assembly 30 is operable to dispense and cut the tendon.

Other processing devices (not shown) in the system 10 may include, for example, a banding/tie device, an anchor (intermediate or dead-end) placement device, a marking device, a material handling device. Also, a stripping device 14 (not shown) may be provided to strip sheathing from the tendon T to facilitate placement/seating of an anchor.

The processing assembly 30 includes a dispenser 34 for dispensing the tendon T into a tub 18 and a shear 38 (e.g., a hydraulic shear) for cutting the tendon T to length. The dispenser 34 includes a conveyor 42 (e.g., one or more belts) for moving tendon T through the device 14 and a guide (e.g., a tube 46) to direct the tendon T into the tub 18.

As shown in FIG. 2, a tub cover 50 (FIG. 2) is positionable to cooperate with a tub 18 to contain the tendon T during dispensing and coiling in the tub 18. The cover 50 includes a top wall 54 and a depending side wall 58 (FIG. 1). The tube 46 extends through a guide opening 62 (FIG. 1) to dispense tendon T into the space defined between the cover 50 and the tub 18. The side wall 58 is segmented to provide openings 66 to access the tendon T in the tub 18.

The cover 50 is movably supported by a support assembly 70 to move between a raised position to facilitate positioning of the tub 18 in the processing position, and a lowered position to contain the tendon T during processing. The assembly 70 includes an arm 74 connected to the frame 26 and a support bar 78 at its free end. Guide shafts 82 are connected to the top wall 54 of the cover 50 and slide in the support bar 78 as the cover 50 moves between the raised and lowered positions. A drive assembly 86 (e.g., a piston) moves the cover 50 between the positions.

As mentioned above, each tub 18 provides a receptacle for receiving and containing a tendon T during processing. Each tub 18 includes a base 90 and a side wall 94. Openings/slots 98 are defined in the base 90 and the side wall 94 to allow access to the tendon T in the tub 18, for further processing, such as banding, marking, etc. Each tub 18 is supported by a respective pivot shaft 102 (FIG. 1) for movement about the axis of the shaft 102. A drive assembly (not shown), such as a drive motor, is operable to rotate the tub 18 about the axis of the shaft 102.

The indexing assembly 22 supports the tubs 18 for movement between the locations of various tendon processing devices 14. The illustrated indexing assembly 22 provides rotary movement of the tubs 18. The indexing assembly 22 includes a base 106 (FIG. 1) supported on the surface S of the work shop. A pivot shaft 110 is supported by the base 106 and supports a support arm assembly for rotational movement about an axis of rotation. The support arm assembly includes multiple radial arms 114 angularly spaced apart about the axis of rotation. The pivot shaft 102 of a tub 18 is supported at the free end of each arm 114 (that is, the end of the arm 114 that is radially spaced apart from the pivot shaft 110). A drive assembly (not shown), such as a drive motor, is operable to rotate the support arm assembly, the arms 114 and the supported tubs 18 about the axis of rotation.

The illustrated system 10 includes six tubs 18a-18f supported on six arms 114. With the illustrated arrangement, the system 10 with six tubs 18 fits in the floor space occupied by a system with only four fixed tubs. In other constructions (not shown), the system 10 may include fewer tubs/arms (e.g., one to five) or more than six tubs 18/arms 114. A system 10 with even a single indexed tub 18 may, for example, reduce the labor, space, cost, etc. typically required for processing the tendon T.

The system 10 also includes a controller (not shown) operable to, among other things, configure, control or automate operation of the system 10 and/or of its components. The controller includes a processing unit (e.g., a microprocessor, a microcontroller, or another suitable programmable device), non-transitory computer-readable media, and an input/output interface. The processing unit, the media, and the input/output interface are connected by one or more control and/or data buses. The computer-readable media stores program instructions and data. The processing unit is configured to retrieve instructions from the media and execute the instructions to perform the control processes and methods described herein.

The input/output interface transmits data from the controller to external systems, networks, and/or devices and receives data from external systems, networks, and/or devices. The input/output interface stores data received from external sources to the media and/or provides the data to the processing unit.

In some independent aspects, the controller in the system 10 provides automated strand coiling in the tub 18. Other automated processing may include intermediate anchor placement, dead-end anchor seating, tendon sheath stripping, identification marking, material handling, etc.

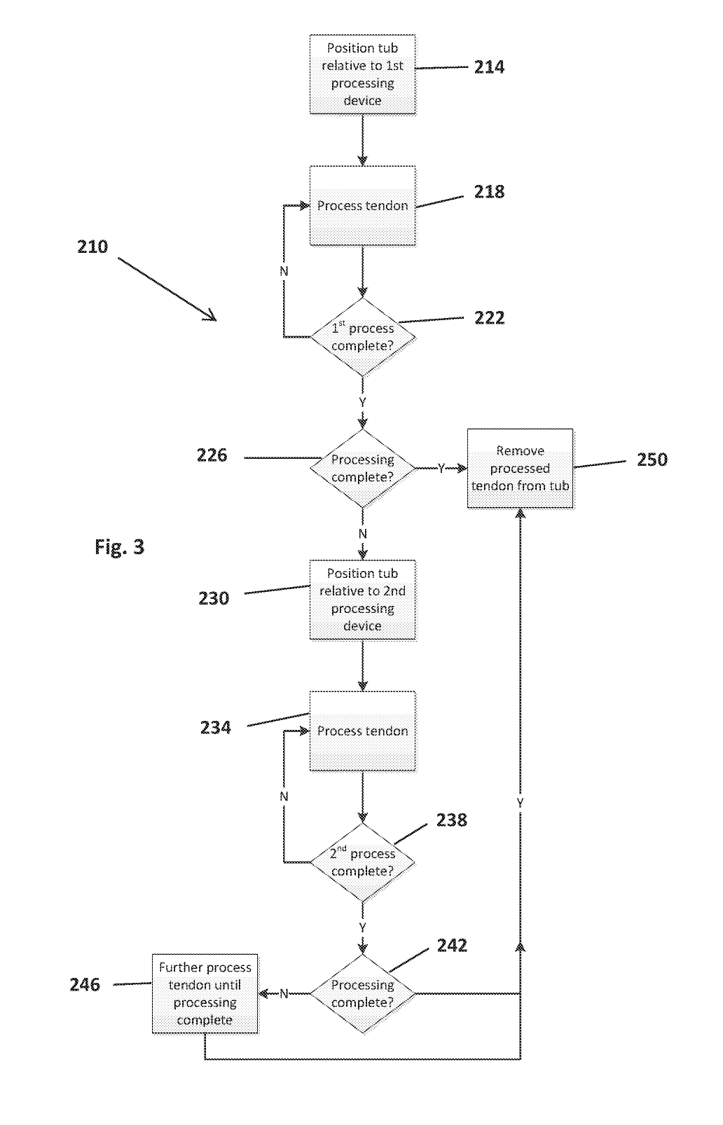

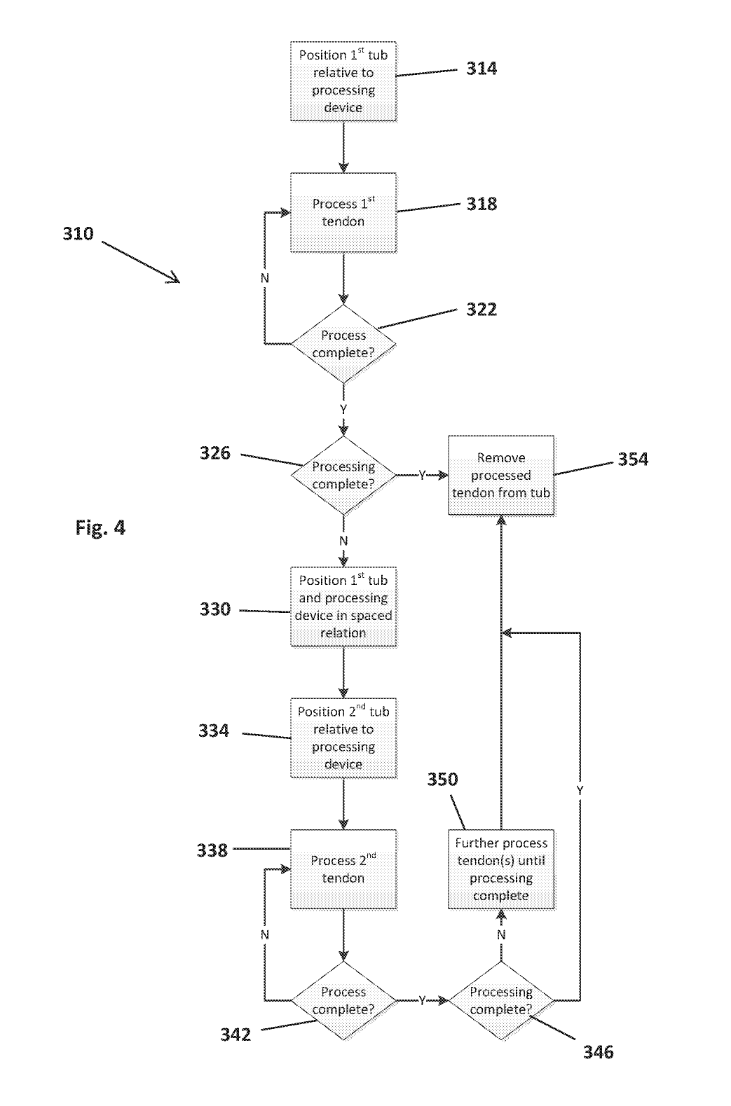

FIGS. 3 and 4 illustrate methods of processing tendon T in the system 10 executed by the controller. FIG. 3 illustrates a method 210 from the perspective of a tub 18a as it receives and moves a tendon Ta through the system 10 for processing at various processing devices 14 (one shown). At step 214, the tub 18a is positioned relative to a first processing device 14, the dispensing and cutting device shown in FIGS. 1 and 2. In the illustrated system 10, the tub 18a is rotated into a processing position for the device 14. At step 218, the tendon Ta is processed, in this case, dispensed and cut by the device 14. During this processing, the tub 18a is rotated about the axis of its pivot shaft 102 to coil the tendon Ta.

At step 222, the process being conducted by the device 14 is evaluated to determine whether it is complete (e.g., the tendon Ta has been cut, dispensed and fully coiled in the tub 18a). If the process is not complete, the method returns to step 218 and through step 222 until complete.

If the process of the device 14 is complete, at step 226, overall processing of the tendon Ta is evaluated to determine whether it is complete. If processing is not complete (e.g., the tendon Ta will undergo further processing by one or more additional processing devices (not shown)), at step 230, the tub 18a is positioned relative to a subsequent processing device (not shown). Again, in the illustrated system 10, the tub 18a is rotated into a processing position for the subsequent device.

At steps 234 and 238, the process of the subsequent device is conducted and evaluated as discussed above for the device 14. Overall processing of the tendon Ta is again evaluated at step 242. If further processing (see step 246) is necessary at further processing devices (not shown), further processing is conducted. Such further processing is conducted in a manner similar to steps 230-242 for each subsequent device.

When processing is complete (at steps 222, 242 or 246), at step 250 the processed tendon Ta is removed from the tub 18a. Removal may be done by a material handling device (not shown).

FIG. 4 illustrates a method 310 from the perspective of a processing device 14 as it processes tendon T (e.g., dispenses and cuts tendon T into tendons Ta, Tb . . . Tn). At step 314, a first tub 18a is positioned relative to the device 14, the dispensing and cutting device shown in FIGS. 1 and 2. In the illustrated system 10, the tub 18a is rotated into a processing position for the device 14. At step 318, the tendon Ta is processed, in this case, dispensed and cut by the device 14. During this processing, the tub 18a is rotated about the axis of its pivot shaft 102 to coil the tendon Ta.

At step 322, the process being conducted by the device 14 is evaluated to determine whether it is complete (e.g., the tendon Ta has been cut, dispensed and fully coiled in the tub 18a). If the process is not complete, the method returns to step 318 and through step 322 until complete.

If the process of the device 14 is complete, at step 326, overall processing of the tendon Ta is evaluated to determine whether it is complete. If processing is not complete (e.g., the tendon Ta will undergo further processing by one or more additional processing devices (not shown)), at step 330, the tub 18a is positioned in spaced relation from the device 14 (e.g., rotated away from the processing position of the device 14) and, as described above, positioned relative to a subsequent processing device (not shown).

At step 334, a second tub 18b is positioned relative to the device 14. The tub 18b is rotated into a processing position for the device 14. At step 338, the tendon Tb is processed, in this case, dispensed and cut by the device 14. During this processing, the tub 18b is rotated about the axis of its pivot shaft 102 to coil the tendon Tb.

At step 342, the process of the device 14 is evaluated as described above for tendon Ta. Overall processing of the tendon T is again evaluated at step 346. If further processing of the tendon T by the device 14 (see step 350), further tendons Tc . . . Tn are processed (e.g., dispensed into tubs 18c . . . 18n and cut). Such further processing is conducted in a manner similar to steps 334-346 for each subsequent device.

When processing is complete (at steps 326, 346 or 350), at step 354, the processed tendons Ta, Tb . . . Tn are removed from the tubs 18a, 18b . . . 18n. Once a tub 18 is empty, the tub 18 can again move through the system 10 as illustrated in the method 210.

As discussed above, in the illustrated system 10, the indexing assembly 22 supports the tub(s) 18 for rotational movement between locations of processing devices 14. In some constructions, the indexing assembly 22 may support the tub(s) 18 for movement along a non-circular path (e.g., generally linearly). In some embodiments, the tubs 18 move along a substantially horizontal plane or direction 52 (FIG. 1), a substantially vertical plane or direction 56, or a combination thereof between the processing devices 14.

The indexing assembly 22 may include a conveyor assembly (not shown) supporting the tub(s) 18 for movement to and between processing devices 14. At the end of the line, the tub(s) 18 may be returned (e.g., by a return conveyor (not shown)) to the start.

In another example (not shown), tubs 18 may be stacked vertically (in a manner similar to a compact disk (CD) player using a cartridge of multiple CDs). A selected tub 18 may be moved from the stack into a processing position for a processing device 14. After the process is completed, the selected tub 18 is returned to the stack (or to a processing position for another processing device 14), and another selected tub 18 is moved from the stack to the processing position.

In the illustrated system 10 and methods described above, the indexing assembly 22 moves the tub(s) 18 into processing positions for various processing devices 14. In other constructions (not shown), the processing device(s) 14 may be moved into position relative to the tub(s) 18. In still other constructions (not shown), the system 10 may include a combination of movable tub(s) 18 and movable processing device(s) 14, along with stationary/fixed tub(s) 18 and/or device(s) 14.

The illustrated system 10 may provide increased processing capacity, including the use of “secondary” operations in the same area, while occupying a smaller footprint. The speed and efficiency of processing the tendon T may also be increased, along with material handling requirements being reduced. In certain independent aspects, operators are not required to attend to each tub, especially during strand coiling, and are thus not exposed to the associated moving components.

The illustrated system 10 may be suitable for a high-level of automation, reducing the human interface at various processing stations. By providing automated control functions, including, for example, machine intelligence integrated into the cutting line process, machine productivity and accuracy may also improve and scrap may be reduced, with reduced operator interface, fatigue and errors.

Preferred embodiments have been described in considerable detail. Many modifications and variations to the preferred embodiments described will be apparent to a person of ordinary skill in the art. Therefore, the disclosure is not limited to the embodiments described.

One or more independent features and independent advantages may be set forth in the claims.

What is claimed is:

1. A tendon processing system comprising:
at least one tub for supporting a tendon; and
an indexing assembly for moving the tub to and between a plurality of processing locations, each processing location associated with at least one respective processing device.

2. The tendon processing system of claim 1, wherein the at least one tub includes a plurality of tubs, each of the tubs supported for movement by the indexing assembly.

3. The tendon processing system of claim 1, wherein the indexing assembly further includes a rotating turntable supporting the tub for movement to and between different processing devices.

4. The tendon processing system of claim 1, wherein the indexing assembly is operable to move the tub between the processing locations in at least one of a vertical direction and a horizontal direction.

5. The tendon processing system of claim 1, wherein the processing device include at least one of a tendon cutting device, a tendon banding device, an anchor placement device, a tendon marking device, and a material handling device.

6. The tendon processing system of claim 1, wherein the tub includes a receptacle for receiving and containing the tendon.

7. The tendon processing system of claim 1, wherein the tub is supported by a pivot shaft for rotation about an axis of the pivot shaft.

8. A tendon processing system comprising:
a tendon processing device;
a tub for supporting a tendon,
wherein at least one of the tendon processing device and the tub is selectively positionable adjacent the other of the tendon processing device and the tub to permit processing of the tendon, at least one of the tendon processing device and the tub being movable away from the other of the tendon processing device and the tub after processing.

9. The tendon processing system of claim 8, wherein the tendon processing device is a first tendon processing device, the tendon processing system further comprising a second tendon processing device, wherein, after processing by the first tendon processing device, at least one of the tub and the second tendon processing device is selectively positionable adjacent the other of the second tendon processing device and the tub to permit further processing of the tendon.

10. The tendon processing system of claim 8, wherein the tub is a first tub, and further comprising a second tub supporting a second tendon, wherein, after processing of the tendon supported by the first tub, at least one of the tendon processing device and the second tub is selectively positionable adjacent the other of the tendon processing device and the second tub to permit processing of the second tendon.

11. The tendon processing system of claim 8, wherein the tendon processing device is stationary and the tub moves relative to the tendon processing device.

12. The tendon processing system of claim 8, wherein the tub is supported on a rotating turntable to move between the tendon processing device and a second processing device.

13. The tendon processing system of claim 8, wherein the tendon processing device includes one of a tendon dispensing device, a tendon tie device, an anchor placement device, a tendon marking device, and a material handling device.

14. The tendon processing system of claim 8, wherein the tendon processing device includes a dispenser and a shear, the dispenser being configured to dispense the tendon into the tub and the shear being configured to cut the tendon to a predetermined length.

15. The tendon processing device of claim 14, wherein the dispenser includes a conveyor and a guide, the conveyor being configured to move the tendon, the guide being configured to direct the tendon into the tub.

16. A method of processing a tendon comprising:
positioning a processing device and a tub for supporting a tendon adjacent one another;
processing the tendon; and
after processing the tendon, moving at least one of the processing device and the tub away from one another.

17. The method of claim 16, further including positioning a second processing device and the tub adjacent one another.

18. The method of claim 16, wherein positioning the processing device and the tub includes moving the tub relative to the processing device.

19. The method of claim 16, wherein positioning the processing device and the tub includes rotating a turntable to move the tub between a first position adjacent the processing device and a second position adjacent a second processing device.

20. The method of claim 16, wherein processing of the tendon includes at least one of dispensing the tendon, cutting the tendon, banding the tendon, tying the tendon, placing an anchor on the tendon, marking the tendon, and handling the tendon.
